(19) United States
(12) Patent Application Publication
(10) Pub. No.: US 2014/0013365 A1
(43) Pub. Date: Jan. 9, 2014

(54) COMMUNICATION DEVICE AND WIRELESS COMMUNICATION SYSTEM

(71) Applicant: Panasonic Corporation, Osaka (JP)

(72) Inventors: Toshihiro EZAKI, Osaka (JP); Satoshi Oyama, Hyogo (JP)

(21) Appl. No.: 13/932,006

(22) Filed: Jul. 1, 2013

(30) Foreign Application Priority Data
Jul. 6, 2012 (JP) 2012-152459
Jun. 18, 2013 (JP) 2013-127654

(51) Int. Cl. H04N 21/214

(52) U.S. Cl. CPC H04N 21/2146
USPC 725/77

(57) ABSTRACT

A communication device wirelessly connected to a seat-side communication device having a wireless communication function disposed on an attachment face of a fixed seat is described herein. The communication device is attached to a moving vehicle that moves substantially parallel to the attachment face of a fixed seat. The communication device comprises first moving vehicle faces disposed substantially parallel to the direction in which the moving vehicle moves and directly face the attachment face of the fixed seat, a second moving vehicle face disposed on the bottom face of the moving vehicle, third moving vehicle faces disposed facing the forward or backward movement direction of the moving vehicle, an antenna component configured to communicate with the seat-side communication device, and a controller configured to control the transmission and reception of data. The antenna component is disposed on at least one of the first, second, and the third moving vehicle faces.

This application claims priority under 35 U.S.C. §119 to Japanese Patent Applications No. 2012-152459 filed on Jul. 6, 2012 and No. 2013-127654 filed on Jun. 18, 2013. The entire disclosure of Japanese Patent Applications No. 2012-152459 and No. 2013-127654 is hereby incorporated herein by reference.

### BACKGROUND OF THE INVENTION

1. Field of the Invention

The disclosure relates to a communication device and a wireless communication system that can communicate with a plurality of other wireless communication devices.

2. Description of the Related Art

In the past, when a system in which a network was connected to a plurality of terminals was used indoors or on an airliner or other such moving vehicle, it was common practice to install and connect a wired network to the terminals.

An example of this is in-flight entertainment systems (hereinafter referred to as IFE), which have become commonplace on today's airliners. With an IFE, a monitor and a controller are installed in each seat of the aircraft, and the passengers can enjoy movies and games on their seat monitors.

The monitors are connected to an onboard wired network, and the content (movies or games) is sent from an onboard server through the wired network.

The transmission method using a wired network has the advantage of being very reliable, but drawbacks are that laying and setting the cables is time-consuming and costly, and maintenance work after setting cables is very labor intensive.

Also, interior space is limited in a moving vehicle, and particularly an airliner, which makes it hard to ensure enough space to lay the cables. Furthermore, in recent years aircraft manufacturers and airlines have been demanding reduced fuel consumption because of the high price of aircraft fuel, but the cables that meet the specifications of airliners are expensive and heavy, so cable setting has posed problems in terms of both cost and fuel consumption.

Meanwhile, wireless networks, in which connections to terminals are made wirelessly, have been proposed for use in airliners, and have been gradually put into use. An advantage of a wireless network over a conventional wired network is that the time and expense of setting and maintaining cables can be reduced.

Also, since wireless connection reduces the weight of wiring and the space that would be taken up by cables, it is extremely advantageous in moving vehicles, and particularly airliners.

The use of devices that emit radio waves is usually forbidden on airliners. This is because of the problem of radio interference with the devices on the aircraft, and the problem of usable wireless frequencies varying from one country to the next.

However, except during takeoff and landing, an onboard wireless LAN (local area network) has little effect on the flight of an airliner, so in recent years airlines have started offering wireless LAN connection service for PC's (personal computers), PDA's (personal digital assistants), and other such devices carried by passengers, during cruising (other than during takeoff and landing).

To describe how an onboard network is converted to wireless operation, first an aircraft network connected by a conventional wired system will be described.

An aircraft network connected by a conventional wired system is wired as shown in FIG. 13, for example. FIG. 13 is a simplified diagram of the configuration of an aircraft as seen from the side, with the left side in the drawing showing the front of the aircraft, 905 being the ceiling, and 906 the floor. In FIGS. 13, 904a and 904b are passenger-use terminals installed in seats (not shown), and provide passengers with service content (movies or games).

The data for these movies and games is itself stored in a server 902 at the front part of the aircraft. The server 902 is connected by a wired network 903 to a first relay 901. A plurality of the first relays 901a are generally installed behind the ceiling 905 of the aircraft, and first relays 901a, 901b, and so forth are sequentially connected in a daisy chain starting at the front of the aircraft.

The first relays 901a and 901b are also connected to the wired network 903, which branches off toward the floor of the aircraft. This wired network 903 is connected to a second relay 907 installed on the floor 906 of the aircraft.

A plurality of these second relays 907 are provided, and the second relays 907a, 907b, and so forth are sequentially connected in a daisy chain starting at the front of the aircraft.

The second relays 907a and 907b are also connected to the above-mentioned passenger-use terminals 904a and 904b. Sometimes a plurality of passenger-use terminals 904 are connected to a single second relay 907.

With an onboard network configured as above, a request to distribute content (movies or games) selected by a passenger with the passenger-use terminal 904b goes along the wired network 903 and first passes through the second relay 907b. After this, the request goes through the second relay 907a located midway before reaching the first relay 901a. After this, the request goes through the first relay 901a if this relay is present before reaching the server 902, and finally reaches the server 902.

The server 902 distributes the necessary content according to the request from this passenger-use terminal 904b. The content travels along the reverse path from that of the request, going through the first relay 901 a and the second relay 907 to reach the passenger-use terminal 904.

If part of this wired network is converted to wireless, the system shown in FIG. 14 is possible. FIG. 14 is a simplified diagram of the configuration of an airliner as seen from the side, with the left side in the drawing showing the front of the aircraft, 1005 the ceiling, and 1006 the floor.

In FIG. 14, 1002 is a server, 1001a and 1001b are first relays, 1007a and 1007b are wireless base stations, and 1004a and 1004b are passenger-use terminals installed in the seats (not shown). The passenger-use terminals 1004a and 1004b have a wireless client function, and are wirelessly connected to the wireless base stations 1007a and 1007b, respectively.

The content stored in the server 1002 goes through a wired network 1003 and is transmitted through the first relays 1001a and 1001b to the wireless base stations 1007a and 1007b.

At the wireless base stations 1007a and 1007b, data received from the wired network is converted into wireless frames and sent to the wireless network. The passenger-use terminals 1004a and 1004b receive these wireless frames, acquire content information (movie or game), and provide this to the passenger.

An onboard network can be constructed from the wireless network, but it is difficult to ensure enough bandwidth for a wireless network merely by automatically connecting wireless terminals to a wireless base station. Particularly when video is distributed or transmitted, it is difficult to ensure stable video quality. Consequently, it is preferable if a wireless terminal can be connected to a wireless base station capable of receiving more stable radio waves.

One common technological means for solving this problem is to use a method in which the combination of wireless base station and wireless terminals to be connected is specified in advance, and the communication conditions or communication situations are registered in the wireless terminals ahead of time. However, the wireless environment in an airliner is extremely unstable, and it is difficult to create a stable wireless network with data that has only been measured once in advance. Also, the installation of equipment in the aircraft is performed by a dedicated installation technician, but since these dedicated technicians are not well versed in wireless networks, it can be difficult for such technicians to set up a wireless network in the aircraft.

A system was disclosed in the past as a technique for dealing with this problem, in which a flight attendant carries a flight attendant-use communication terminal, and the flight attendant can carry out optical communication as needed while moving along an aisle located between seats (see Japanese Laid-Open Patent Application H11-234208, for example).

With the above-mentioned prior art, however, it was difficult to ensure a stable wireless band for each of the wireless terminals. Particularly when video is being distributed, a constant communication band needs to be ensured at all times for each and every wireless terminal. However, since the wireless environment inside an aircraft can vary greatly with the situation, there can be significant discrepancy from the radio wave strength measured ahead of time.

Thus, with prior art, it was difficult to optimize the combination of wireless base station and wireless terminal for an entire system, and to achieve a state in which the communication band is ensured even with individual connections.

### SUMMARY

This disclosure provides a communication device and a wireless communication system that is effective for achieving stable and efficient wireless communication.

The communication device disclosed herein is capable of communicating with one other communication device attached to an attachment face on a fixed object. The communication device is attached to a moving vehicle that moves substantially parallel to the attachment face on the fixed object. The communication device comprises a first moving vehicle face disposed so as to be substantially parallel to a direction in which the moving vehicle moves, the first moving vehicle face facing the attachment face on the fixed object, a second moving vehicle face disposed on a bottom face of the moving vehicle, a third moving vehicle face disposed so as to face in a forward or backward movement direction of the moving vehicle, an antenna component configured to wirelessly send and receive data to and from the one other communication device, and a controller configured to control transmission and reception of the data. The antenna component is disposed on one or more of the first moving vehicle face, the second moving vehicle face and the third moving vehicle face, or on a line of intersection between any two of the first moving vehicle face, the second moving vehicle face and the third moving vehicle face.

The communication device disclosed herein is capable of wireless communication with one other communication device, and is attached to a fixed object adjacent to an aisle that allows passage of a moving vehicle. The communication device comprises a first attachment face disposed so as to face the aisle, an antenna component configured to wirelessly send and receive data to and from the one other communication device, and a controller configured to control transmission and reception of the data, wherein at least the antenna component is disposed on the first attachment face.

The wireless communication system disclosed herein comprises a first communication device attached to a moving vehicle that moves along an aisle, and a second communication device provided on a fixed object and including a wireless communication function disposed on a first attachment face that is substantially parallel to a direction in which the moving vehicle moves. The first communication device includes a first moving vehicle face disposed so as to be substantially parallel to the direction in which the moving vehicle moves, the first moving vehicle facing the first attachment face on the fixed object, a second moving vehicle face disposed on a bottom face of the moving vehicle, a third moving vehicle face disposed so as to face in a forward or backward movement direction of the moving vehicle, a first antenna component, and a first controller configured to control transmission and reception of data. The first antenna component is disposed on one or more of the first moving vehicle face, the second moving vehicle face and the third moving vehicle face, or on a line of intersection between any two of the first moving vehicle face, the second moving vehicle face and the third moving vehicle face. The first antenna component is configured to wirelessly send and receive the data to and from the second communication device. The second communication device includes the first attachment face disposed so as to face the first moving vehicle face, a second antenna component disposed on the first attachment face and configured to wirelessly send and receive data to and from the first communication device, and a second controller configured to control transmission and reception of the data.

The wireless communication device and wireless communication system disclosed herein are effective at achieving stable and efficient wireless communication.

### BRIEF DESCRIPTION OF DRAWINGS

FIG. 1 shows the usage state of the wireless communication system in an embodiment;

FIG. 2 shows the usage state of the wireless communication system in FIG. 1 from the side;

FIG. 3 is a diagram of the configuration of an in-flight entertainment system to which the wireless communication system of the embodiment has been applied;

FIG. 4 shows an example of a seat-side communication device of the wireless communication system in the embodiment;

FIG. 5 shows an example of a moving-side communication device of the wireless communication system in the embodiment;

FIG. 6 is a flowchart of the processing performed by the wireless communication system in the embodiment;

FIG. 7 shows an example of the layout of the seat-side communication device of the wireless communication system in the embodiment;

FIG. 8 shows an example of the layout of the moving-side communication device of the wireless communication system in the embodiment;

FIG. 9 is a diagram of the configuration of an in-flight entertainment system in another embodiment;

FIG. 10 is a flowchart of the processing performed by the wireless communication system in another embodiment;

FIG. 11 is a flowchart of the processing performed by the wireless communication system in another embodiment;

FIG. 12 is a diagram of the configuration of an in-flight entertainment system in another embodiment;

FIG. 13 is a diagram of the configuration of a conventional in-flight entertainment system; and

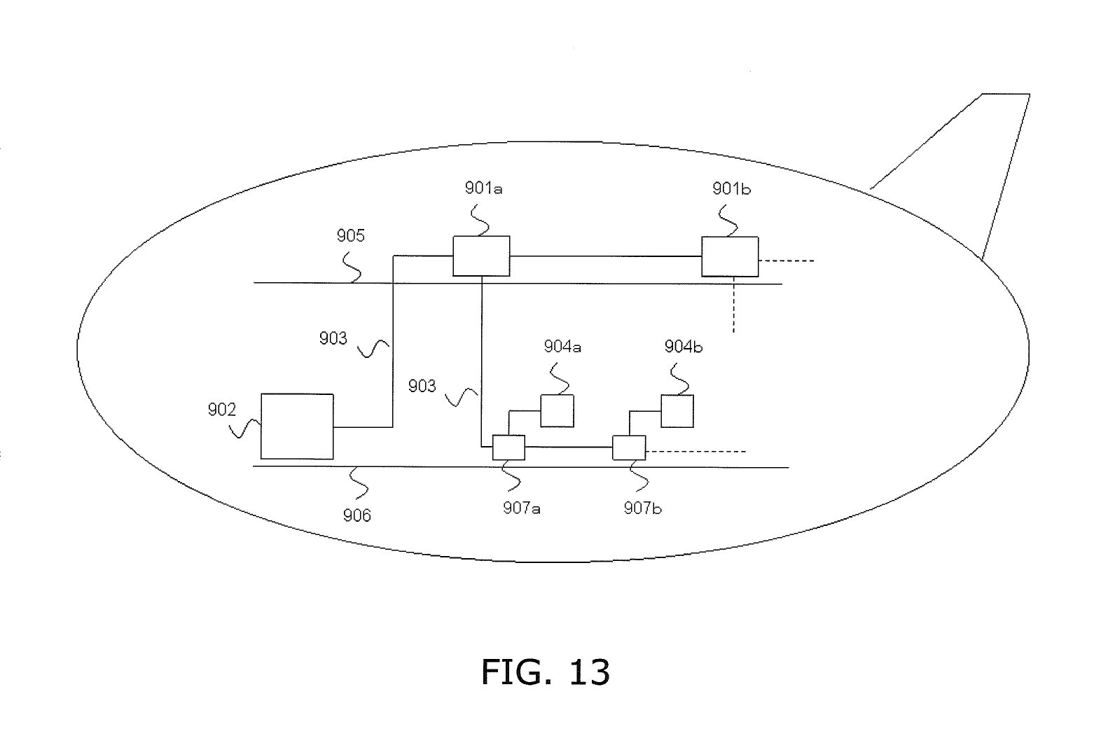

FIG. 14 is a diagram of the configuration of the wireless communication system in a conventional in-flight entertainment system.

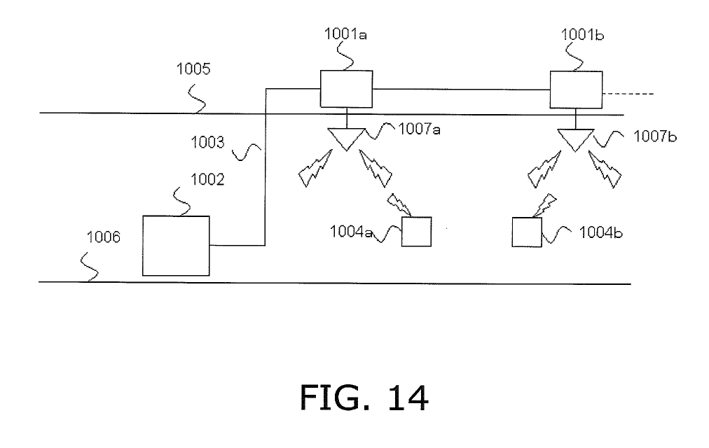

### DETAILED DESCRIPTION

Embodiments will be described in detail through reference to the drawings as needed. Description that is more detailed than necessary may be omitted. For example, detailed description of things that are already known or redundant description of components that are substantially the same may be omitted. The purpose of this is to avoid making the following description overly repetitive, and to facilitate understanding for a person skilled in the art. It will be apparent to those skilled in the art from this disclosure that the following descriptions of the embodiments are provided for illustration only and not for the purpose of limiting the invention as defined by the appended claims and their equivalents.

Furthermore, the inventors provide the appended drawings and the following description so that a person skilled in the art will fully understand what is disclosed herein, and do not intend thereby to limit the subject of what is discussed in the patent claims.

Unless otherwise specified, those symbols, labels, and numbers that are the same in this description indicate the same constituent elements. Also, unless otherwise specified, constituent elements that are not essential to the present invention will not be depicted.

Embodiments of the present invention will be described through reference to the drawings.

### Embodiments

### 1-1. Overview of In-Flight Entertainment System 3

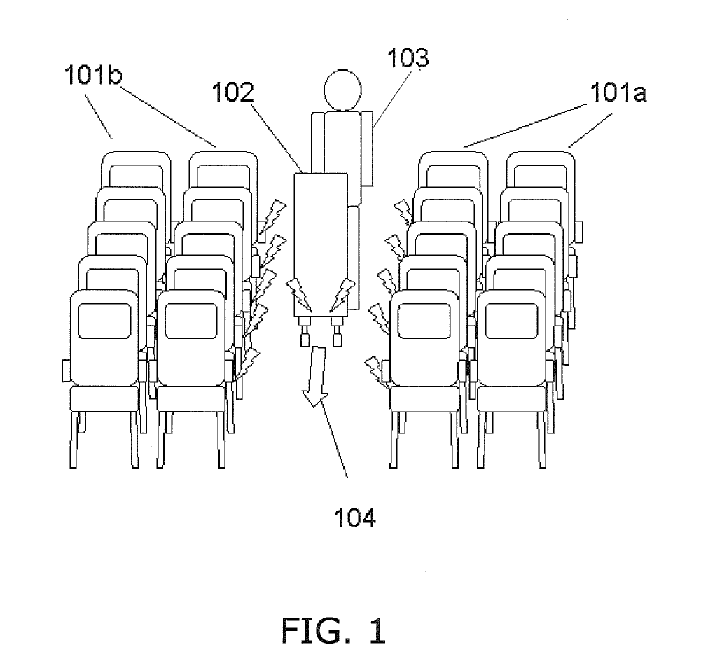

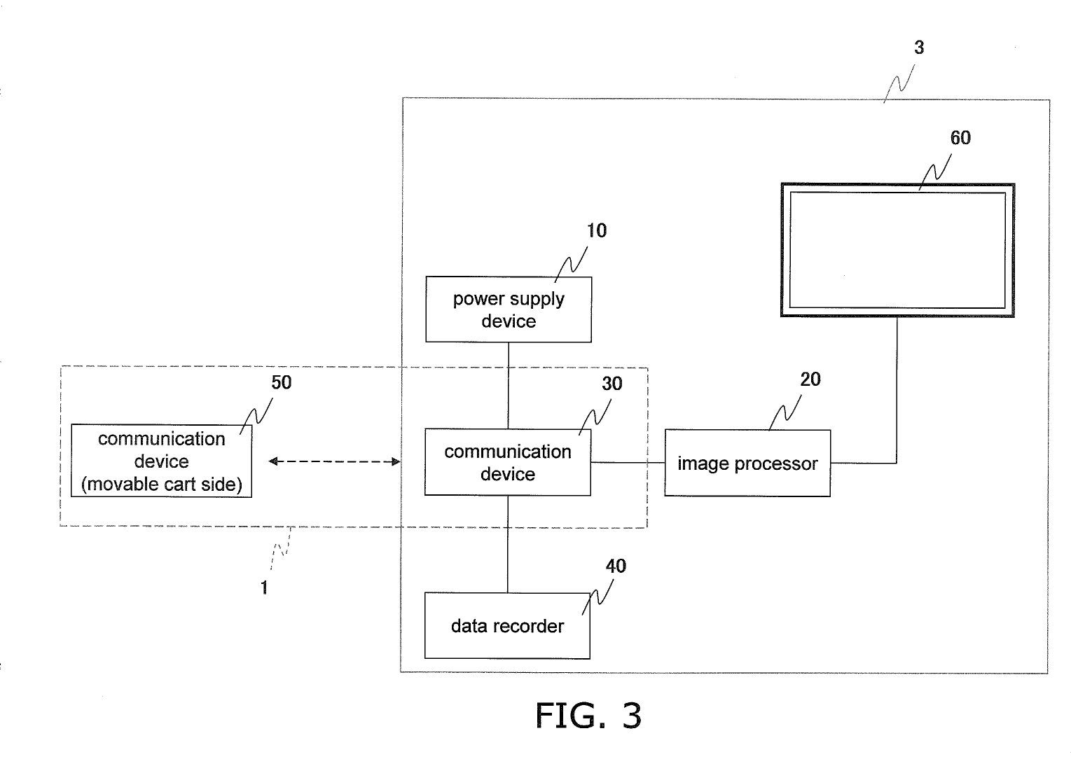

FIG. 1 shows the usage state of an in-flight entertainment system 3 featuring the wireless communication system 1 in this embodiment (FIG. 3). The wireless communication system 1 in this embodiment comprises a communication device 30 and a communication device 50 (discussed below).

In FIGS. 1, 101a and 101b are seats installed in transportation, such as an aircraft or a train (such as the Shinkansen). The communication device 30 (discussed below) is provided to each seat, and the seat also has a wireless communication function and the function of receiving information (namely, entertainment information such as video, sounds, games or communication, or business service information) from an onboard server and displaying it. 102 is a movable cart. The movable cart 102 is generally used to offer merchandise for sale (such as duty-free goods) or to serve food and drinks. The movable cart 102 also has a communication device equipped with a wireless communication function (discussed below). 103 is a flight attendant who provides service to passengers. 104 is an arrow indicating the direction of movement of the movable cart 102.

In this embodiment, the seats 101a and 101b used in transportation (an aircraft here) are described as an example, but these may instead be a plurality of seats located in the stadium of a sports facility, a concert hall, a meeting room, or the like.

In this embodiment, the movable cart 102 is equipped with casters, but is not limited to being a cart, and may be a means for conveying things such as special trays, bags or the like, or a special tool such as a tablet.

In this embodiment, 103 is a flight attendant, but may instead be a worker in charge of maintenance or cleaning of devices or equipment installed on the aircraft.

In this embodiment, the arrow 104 indicating the movement direction is shown as indicating one direction, but is not intended to limit the orientation.

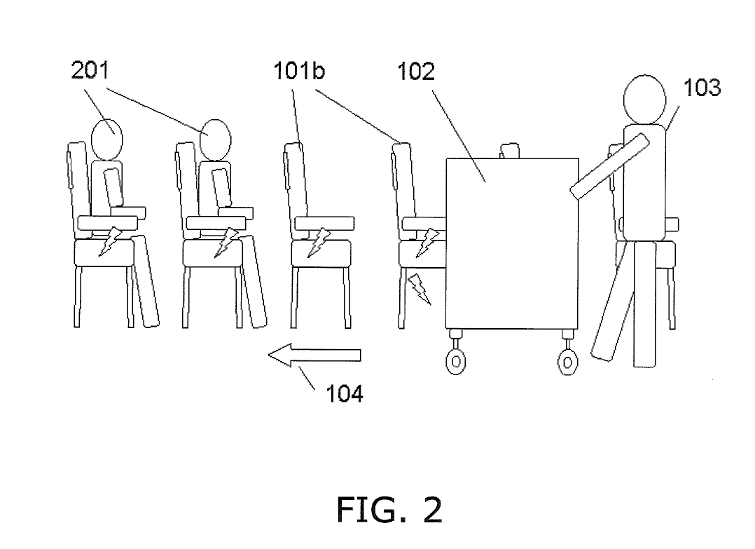

The operation of the wireless communication system 1 in this embodiment configured as above will be described through reference to FIG. 2. FIG. 2 shows the system configuration in FIG. 1 when seen from the side.

The flight attendant 103 usually pushes the movable cart 102 in the movement direction 104 while offering food and beverage service or the sale of merchandise to the passengers 201 sitting in the seats 101b. Meanwhile, the passengers 201 who are provided service by the flight attendant 103 can enjoy movies, music, games, or communication (entertainment service) by using the communication devices installed in the seats 101b while sitting in the seats 101b.

Also, in addition to the normal service provided by the flight attendant 103, the flight attendant 103 uses the wireless communication system 1 of this embodiment to send and record entertainment service content (video, audio, or games) pre-stored in the movable cart 102 to the communication devices of the seats 101b by using the wireless communication function of the communication devices of the seats 101b and the wireless communication function of the communication device of the movable cart 102.

In general, wireless communication is greatly affected by changes in the wireless environment due to the coming and going of people and objects, and in some cases communication may even become impossible. With the wireless communication system 1 in this embodiment, however, because the aisle width is limited by the movable cart 102 or the flight attendant 103 while merchandise sales and food and beverage service are being provided, there is extremely little coming and going of people.

As discussed above, communication interference between the wireless communication function of the seats 101b and the wireless communication function of the movable cart 102 can be eliminated (a state of little foot traffic can be achieved), so highly efficient communication is possible.

In this embodiment, an example is given in which the flight attendant 103 is providing ordinary service, but a similar effect can be anticipated when device and equipment maintenance workers or cleaning workers who work when there are no passengers 201 present are using a means for conveying things such as special trays, bags or the like, or a special tool such as a tablet, to send content to the communication devices of the seats 101b, and record this content to the communication devices.

### 1-2. Configuration of In-Flight Entertainment System 3

Next, the configuration of the in-flight entertainment system 3 to which the wireless communication system 1 pertaining to this embodiment is applied will be described through reference to FIG. 3.

As shown in FIG. 3, the in-flight entertainment system 3 pertaining to this embodiment comprises a power supply device 10, an image processor 20, a communication device 30 (hereinafter referred to as the seat-side communication device 30), a monitor 60, and a data recorder 40. The power supply device 10 supplies power to the various devices of the in-flight entertainment system 3. The seat-side communication device 30 is connected by wire to the power supply device 10, and sends and receives data to and from other devices. The image processor 20 is connected by wire to the seat-side communication device 30, receives transmitted content (video, audio, etc.), and performs image processing. The monitor 60 is attached to the back, etc., of the seat, receives video and audio that has undergone image processing from the image processor 20, and outputs this. The data recorder 40 is a recording medium for recording content information and other such data received by the seat-side communication device 30. As discussed below, the seat-side communication device 30 is connected by wireless communication with a communication device 50 attached to the movable cart 102 (hereinafter referred to as the moving-side communication device 50).

Although not depicted in the drawings, the image processor 20 that receives power and content data from the seat-side communication device 30 comprises a power supply for sending the supplied power to the monitor 60 and converting it into the desired voltage, and an audio/video data processing function for decoding encoded content and sending audio and video in a specific format to the monitor 60.

### 1-2-1. Configuration of Seat-side Communication Device 30

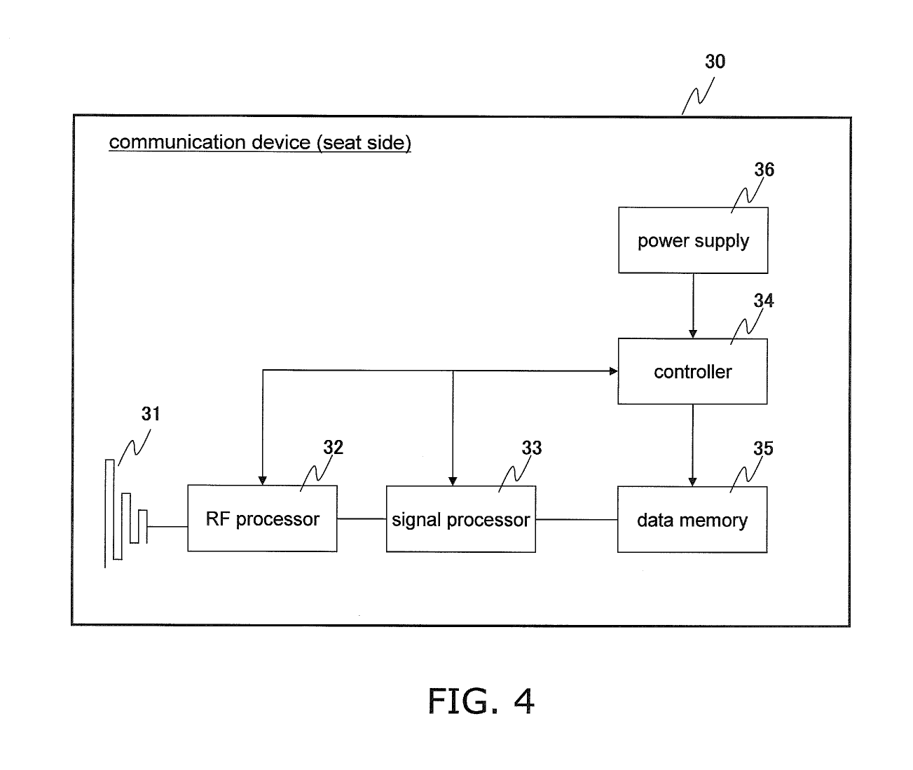

The seat-side communication device 30 in this embodiment (an example of a communication device or a second communication device) is attached to a seat and as shown in FIG. 4, it comprises an antenna component 31 (an example of an antenna component or second antenna component), an RF processor 32, a signal processor 33, a controller 34 (an example of a controller or a second controller), a data memory 35, and a power supply 36. The RF processor 32, the signal processor 33, and the controller 34 are activated by a CPU (central processing unit) that executes functions according to a specific program, for example.

The antenna component 31 includes a wireless antenna, and sends RF signals including the content received from the moving-side communication device 50, as well as commands, requests, and responses. The antenna component 31 sends the moving-side communication device 50 RF signals including content information that has been processed by the signal processor 33 and the RF processor 32 according to instructions from the controller 34, as well as commands, requests, and responses.

The RF processor 32 performs wireless communication processing such as demodulation on specific RF signals received via the antenna component 31 according to instructions from the controller 34. The RF processor 32 also performs wireless communication processing such as modulation of data processed by the signal processor 33 according to instructions from the controller 34, as an RF signal.

The signal processor 33 performs various kinds of signal processing on the signals sent and received according to instructions from the controller 34.

The controller 34 controls the transmission and reception of data to and from the moving-side communication device 50, controls processing of various components in the seat-side communication device 30, and writes and reads data to and from the data memory 35.

The data memory 35 converts the data that has undergone signal processing and produced by the signal processor 33 into a specific encoded format as needed according to instructions from the controller 34, and stores the result.

The power supply 36 transforms the supplied power into the desired voltage, and supplies power to the controller 34.

The each individual component of the seat-side communication device 30 does not necessarily need to be formed, and some or all of it may be constituted inside a single chip.

### 1-2-2. Configuration of Moving-side Communication Device 50

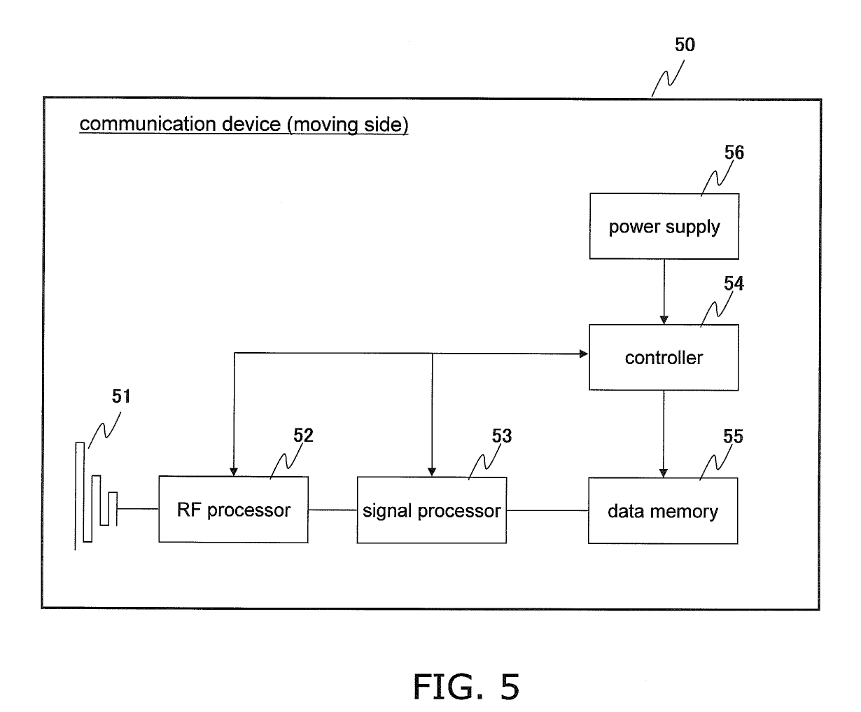

The moving-side communication device 50 in this embodiment (an example of a first communication device) is attached to the movable cart 102 and as shown in FIG. 5, it comprises an antenna component 51 (an example of an antenna component or a first antenna component), an RF processor 52, a signal processor 53, a controller 54 (an example of a communication or a first controller), a data memory 55, and a power supply 56. The RF processor 52, the signal processor 53, and the controller 54 are activated by a CPU (central processing unit) that executes functions according to a specific program, for example. The antenna component 51, the RF processor 52, the signal processor 53, the controller 54, the data memory 55, and the power supply 56 have the same functions as the components of the seat-side communication device 30, and therefore will not be described again.

### 1-3. Operation of In-Flight Entertainment System 3

Next, the operation of the in-flight entertainment system 3 will be described in specific terms by following the flow of signals.

The power supply device 10 is supplied with AC power from a device in the aircraft, etc. The power supply device 10 has the function of converting the AC power into the DC power required by the various devices, and supplies this DC power through cables, etc., to the seat-side communication device 30.

Upon receiving power, the seat-side communication device 30 sends the power provided from the power supply device 10 to the image processor 20. The seat-side communication device 30 sends the image processor 20 power and the content data selected by a passenger 201. The image processor 20 decodes the encoded content data (hereinafter referred to as content) and the power received from the seat-side communication device 30, and then sends video and audio signals and power to the monitor 60. Upon receiving the video and audio signals and power, the monitor 60 displays the video selected by the passenger 201 on a screen, and at the same time provides audio to the passenger 201 via an audio output interface built into the device.

In this embodiment, the power supply device 10 converts AC power into DC power and supplies it to other devices, but does not necessarily have to convert it into DC power.

### 1-3-1. Data Transmission and Reception Between Communication Devices

Next, the processing performed by the seat-side communication device 30 and the moving-side communication device 50 of the wireless communication system 1 in this embodiment will be described. In the following description, the seat-side communication devices 30 of the seats 101a and 101b and the moving-side communication device 50 of the movable cart 102 will be used as examples.

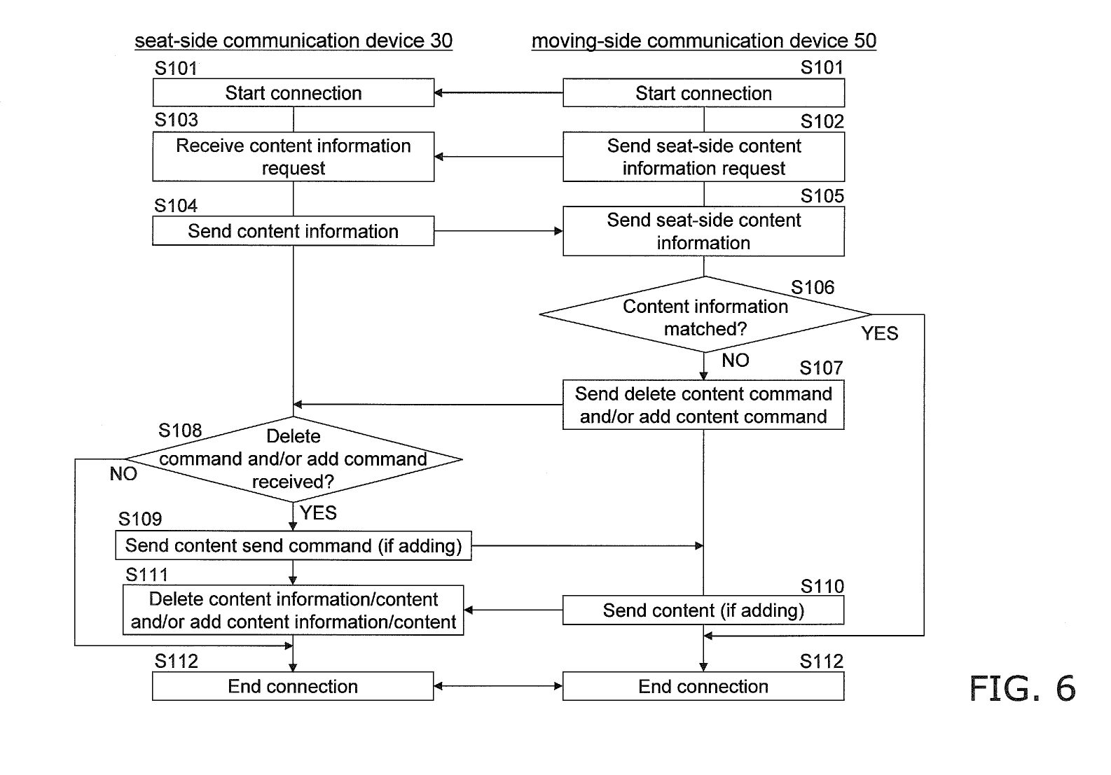

The flow of data transmission and reception and control commands of the moving-side communication device 50 and the seat-side communication device 30 will be described through reference to FIG. 6.

Step S101: The seat-side communication device 30 and the moving-side communication device 50 begin connecting. This connection is begun when the movable cart 102 moves near a specific seat and the arrival range of radio waves from the antenna of the moving-side communication device 50 overlaps the reception range of the antenna of the seat-side communication device 30. This connection is executed according to a known wireless LAN system (such as WiFi), for example. For instance, the moving-side communication device 50 starts emitting a beacon, and when this beacon is received by the seat-side communication device 30, connection processing is performed between the seat-side communication device 30 and the moving-side communication device 50 on the basis of a specific shared ID (such as SSID).

Step S102: Once a connection has been established, the moving-side communication device 50 sends the seat-side communication device 30 a request to find the content information currently held in the seat-side communication device 30 (content titles, ID information, and other such information that identifies the content).

Step S103: The seat-side communication device 30 receives a content information transmission request from the moving-side communication device 50.

Step S104: The seat-side communication device 30 sends the content information it is holding to the moving-side communication device 50 in response to the request in step S103.

Step S105: The moving-side communication device 50 receives the content information from the seat-side communication device 30.

Step S106: The moving-side communication device 50 checks and compares the content information received from the seat-side communication device 30 with the content information it is holding itself, and identifies the content that is to be added or deleted.

Step S107: If content is to be deleted, the moving-side communication device 50 sends a content delete command to the seat-side communication device 30. If content is to be added, the moving-side communication device 50 sends a content add command to the seat-side communication device 30.

Step S108: If the seat-side communication device 30 has received a content delete command and/or a content add command from the moving-side communication device 50, the flow proceeds to step S109.

Step S109: If a content add command has been received, the seat-side communication device 30 performs preparation processing to store the content in the data memory 35. As soon as the preparation processing to store the content in the data memory 35 is complete, a content send command is produced and sent to the moving-side communication device 50.

Step S110: If a content send command has been received from the seat-side communication device 30, the moving-side communication device 50 begins transmission of the content being added. More specifically, content is read and transferred from the data memory 55 storing the content to be added.

Step S111: If a content delete command has been received, the seat-side communication device 30 updates the content information and at the same time executes the deletion of the content stored in the data memory 35. If a content add command has been received, the seat-side communication device 30 updates the content information and at the same time stores the content that has been transferred from the moving-side communication device 50 in the data memory 35.

The exchange of data between the seat-side communication device 30 and the moving-side communication device 50 is checked, and if the content to be added has been successfully transferred to the seat-side communication device 30 and stored in the data memory 35, the content information is updated by the controller 34 inside the seat-side communication device 30.

Step S112: Connection is terminated. For instance, connection is terminated when the movable cart 102 moves away from the seat and the arrival range of the radio waves from the antenna of the moving-side communication device 50 are beyond the reception range of the antenna of the seat-side communication device 30.

As discussed above, content can be added to or deleted from the seat-side communication device 30 by executing data communication between the seat-side communication device 30 and the moving-side communication device 50 as discussed above.

### 1-3-2. Flow of Communication Device Power

The flow of power in the seat-side communication device 30 and the moving-side communication device 50 will now be described.

The seat-side communication device 30 receives power from the power supply device 10 (FIG. 3) with the power supply 36, and supplies power to the data memory 35, the signal processor 33, and the RF processor 32 via the controller 34.

Meanwhile, the moving-side communication device 50 inputs power supplied from the outside or from a built-in battery device to the power supply 56, and supplies power to the data memory 55, the signal processor 53, and the RF processor 52 via the controller 54.

### 1-4. Layout of Wireless Communication System 1

### 1-4-1. Layout of Seat-side Communication Device 30

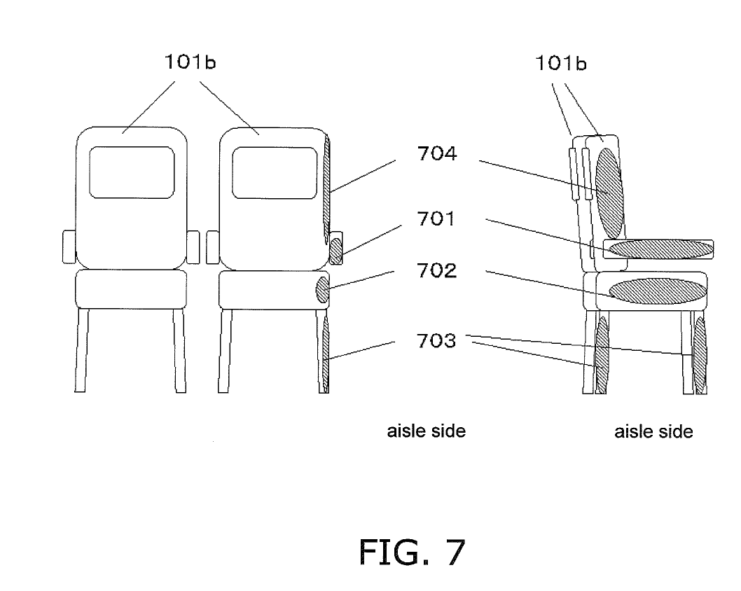

Next, the installation position of the seat-side communication device 30 mounted on the seats 101a and 101b in the wireless communication system 1 in this embodiment will be described through reference to FIG. 7.

FIG. 7 shows a seat 101b when viewed from the rear and from the side.

As discussed above, the seat-side communication device 30 communicates wirelessly with the moving-side communication device 50 at the movable cart 102.

The radio waves used in wireless communication are generally such that the wireless signal level is higher for direct waves than for reflected waves, and with direct waves, there is little data loss during demodulation and stable reception of data . Therefore, it is preferable to eliminate any obstacles between the wireless communication devices (that is, people moving back and forth, or obstructions).

Thus, the seat-side communication device 30 is disposed so as to face the aisle side of the seat 101b. Particularly in the case of wireless communication, the communication efficiency will be better if the polarization plane of radio waves sent out wirelessly from the transmission side is matched to the polarization plane of radio waves received wirelessly on the reception side.

Thus, as shown in FIG. 7, the seat-side communication device 30 will be able to communicate effectively with the moving-side communication device 50 if it is disposed on an aisle-side vertical face 701 on the arm of the seat, an aisle-side vertical face 702 on the seat cushion, aisle-side vertical faces 703 on the seat legs, or an aisle-side vertical face 704 on the seat back (an example of a first attachment face or an attachment face).

Another reason why the above layout is preferable is that if the seat-side communication device 30 were installed on a horizontal face on the armrest of the seat, it is very likely that the passenger 201 would rest his arm on it, making it more likely that the arm would hinder wireless communication. However, if the seat-side communication device 30 is installed on a horizontal face on the underside of the armrest, wireless communication will be blocked by the passenger 201 less than with installation on a horizontal face on the upper side of the armrest.

Also, if the seat-side communication device 30 is installed on a horizontal face on the seat cushion, the passenger 201 will sit on it, making it very likely that wireless communication will be hampered. However, if the seat-side communication device 30 is installed on a horizontal face on the underside of the seat cushion, wireless communication will be blocked by the passenger 201 less than with installation on a horizontal face on the upper side of the seat cushion.

If the installation is on a horizontal face on the seat legs, the passenger 201 will have little effect as long as there are no physical installation restrictions.

In this embodiment, the places where the seat-side communication device 30 is installed are the aisle-side vertical face 701 on the arm of the seat, the aisle-side vertical face 702 on the seat cushion, the aisle-side vertical faces 703 on the seat legs, and the aisle-side vertical face 704 on the seat back, but the installation is not necessarily limited to vertical faces, and a specific effect can be anticipated even with installation on a horizontal face (an example of a second attachment face), so long as the site is on the aisle side.

Also, of the places where the seat-side communication device 30 is installed in this embodiment, the side vertical faces 703 on the seat legs are efficient, but the location is not limited to just the seat legs, and the same effect can be anticipated when the installation is on a vertical face on the cover or surround that covers the front and back of the seat legs.

Also, the seat-side communication device 30 may be installed at a plurality of locations. The seat-side communication device 30 may also be disposed so that it lies on a line of intersection between a horizontal face and a vertical face.

The layout of the seat-side communication device 30 was described in this embodiment, but just the antenna component 31 of the seat-side communication device 30 may be disposed at the above-mentioned places, and the other components (some or all of the RF processor 32, the signal processor 33, the controller 34, the data memory 35, and the power supply 36) may be installed and connected at some other location.

Also, communication between the seat-side communication device and the movable cart 102 was described in this embodiment, but the communication partner is not limited to this, and the present embodiment is also effective in communication with a wireless communication device (wireless access point) fixed to the ceiling.

### 1-4-2. Layout of Moving-side Communication Device 50

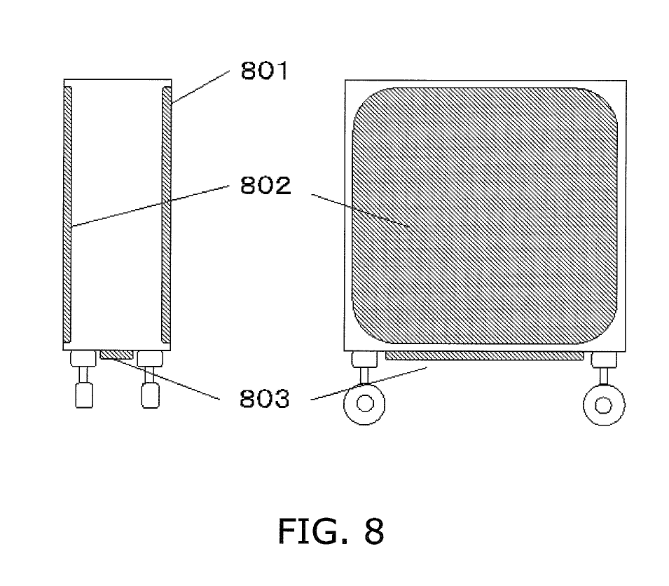

Next, the installation position of the moving-side communication device 50 mounted on the movable cart 102 in the wireless communication system 1 in this embodiment will be described through reference to FIG. 8.

FIG. 8 shows the movable cart 102 when viewed from the longitudinal direction and from the side. As discussed above, the moving-side communication device 50 communicates wirelessly with the seat-side communication device 30 at the seats 101a and 101b.

As mentioned above, it is generally preferable in wireless communication to eliminate obstacles between the wireless communication devices (that is, people moving back and forth, or obstructions). Thus, places on the movable cart 102 that face the seats are preferable as physical installation places for the moving-side communication device 50.

In particular, with wireless communication, the communication efficiency will be better if the polarization plane of radio waves sent out wirelessly from the transmission side is matched to the polarization plane of radio waves received wirelessly on the reception side.

Because of the above, as shown in FIG. 8, the moving-side communication device 50 is preferably installed on a side face 801 or 802 (an example of a moving vehicle face or a first moving vehicle face) where the movable cart 102 is always facing the seats during its movement. However, even if the moving-side communication device 50 is installed on the bottom face of the movable cart 102 or another such horizontal face (an example of a second moving vehicle face), obstruction of communication by the passengers 201 can be suppressed as long as the location is at the bottom 803 as shown in FIG. 8.

The same effect can be anticipated when the moving-side communication device 50 is installed on the front or rear face in the movement direction of the movable cart 102 (an example of a third moving vehicle face), since nearby obstacles between the wireless communication devices can be avoided. Also, the rear face of the movable cart 102 may not be able to serve as an installation face in the portion where food trays and so forth are put in and taken out, but the moving-side communication device 50 can be installed at the edges of this face.

In this embodiment, the place where the moving-side communication device 50 is installed is the side face 801 or 802, but is not limited to just one of these, and may be installed on both. Also, the moving-side communication device 50 may be disposed so as to lie on a line of intersection between the side faces 801 and 802.

The layout of the moving-side communication device 50 was described in this embodiment, but just the antenna component 51 of the moving-side communication device 50 may be installed at the above-mentioned location, and the other components (some or all of the RF processor 52, the signal processor 53, the controller 54, the data memory 55, and the power supply 56) may be installed and connected at some other location.

Also, the movable cart 102 had a cuboid shape in this embodiment, but is not limited to this, and may have any shape so long as the positional relation between communication devices remains the same.

### 1-5. Effect, etc.

The above configuration makes it possible to ensure a stable communication band by disposing the seat-side communication device 30 attached to the seats 101a and 101b and the moving-side communication device 50 attached to the movable cart 102 in a certain way.

Also, by moving the movable cart 102, communication output can be suppressed by decreasing the distance between terminals during communication, and interference with other devices or within the same wireless band can be reduced.

Also, installing the antenna on a side of the movable cart that faces the seats eliminates objects that might block communication between the moving-side communication device 50 and the seat-side communication device 30, and allows better communication efficiency to be anticipated.

If the configuration is such that the moving-side communication device 50 can be connected to the seat-side communication device 30 in an ad hoc mode, stable wireless communication can be performed at a shorter distance, which affords higher speed.

### Other Embodiments

An embodiment of the present invention was described above through reference to the drawings, but the specific constitution of the present invention is not limited to or by the above embodiment, and various changes and modifications are possible without departing from the gist of the invention. For example, the following modifications are possible.

(1)

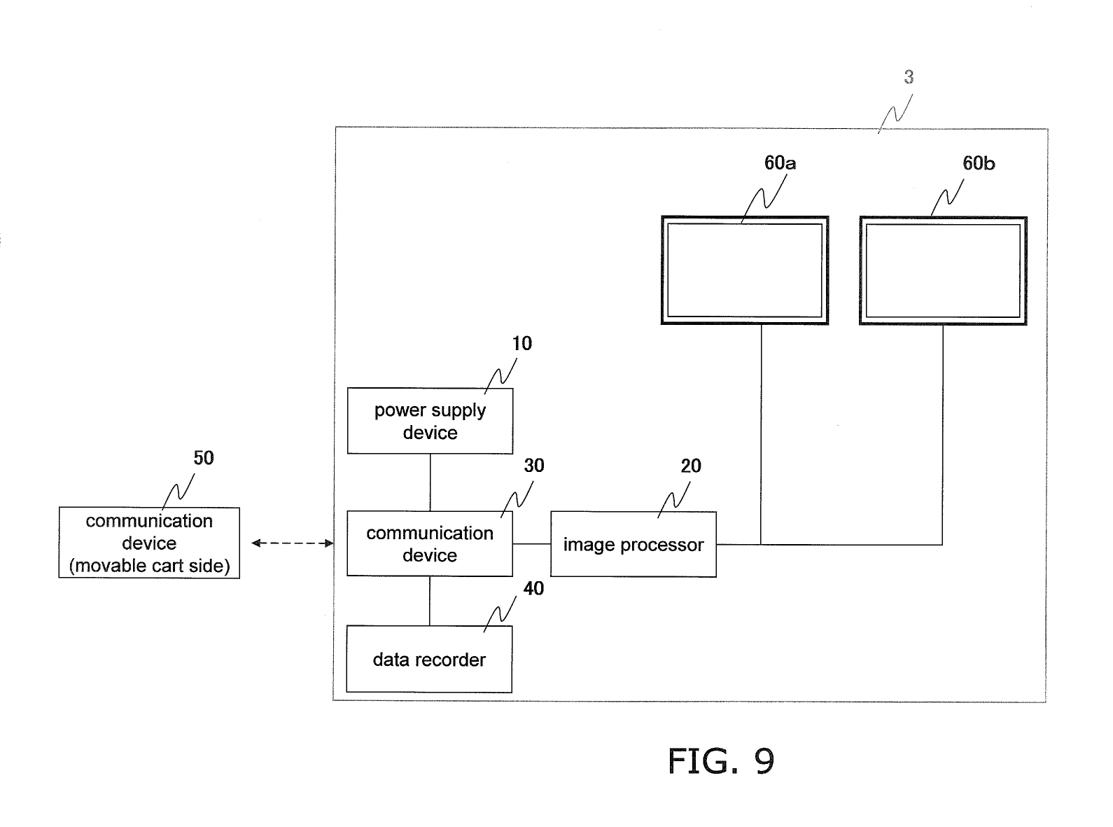

The image processor 20 shown in FIG. 9 may provide video and audio service as well as supplying power to a plurality of monitors 60a and 60b. There may also be three or more monitors.

In the above embodiment, the seat-side communication device 30 was disposed on the aisle side (and particularly on a vertical face). The seats are usually disposed with a number of seats in each row (in a direction perpendicular to the aisle), with the aisle between the rows. Thus, communication efficiency could suffer for seats that are not on the aisle. Therefore, a stable communication band can be ensured by disposing the seat-side communication device 30 (or just the antenna component 31) only at seats that are on the aisle (the vertical rows of seats that are along the aisle), and connect a plurality of monitors (or devices other than the antenna component 31) to these seat-side communication devices 30 at the seats that are not on the aisle.

(2)

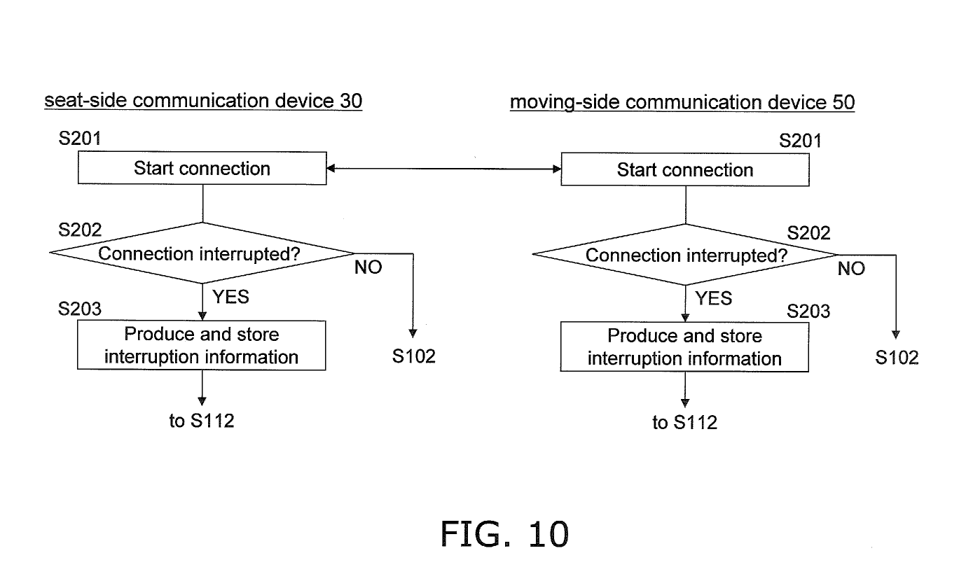

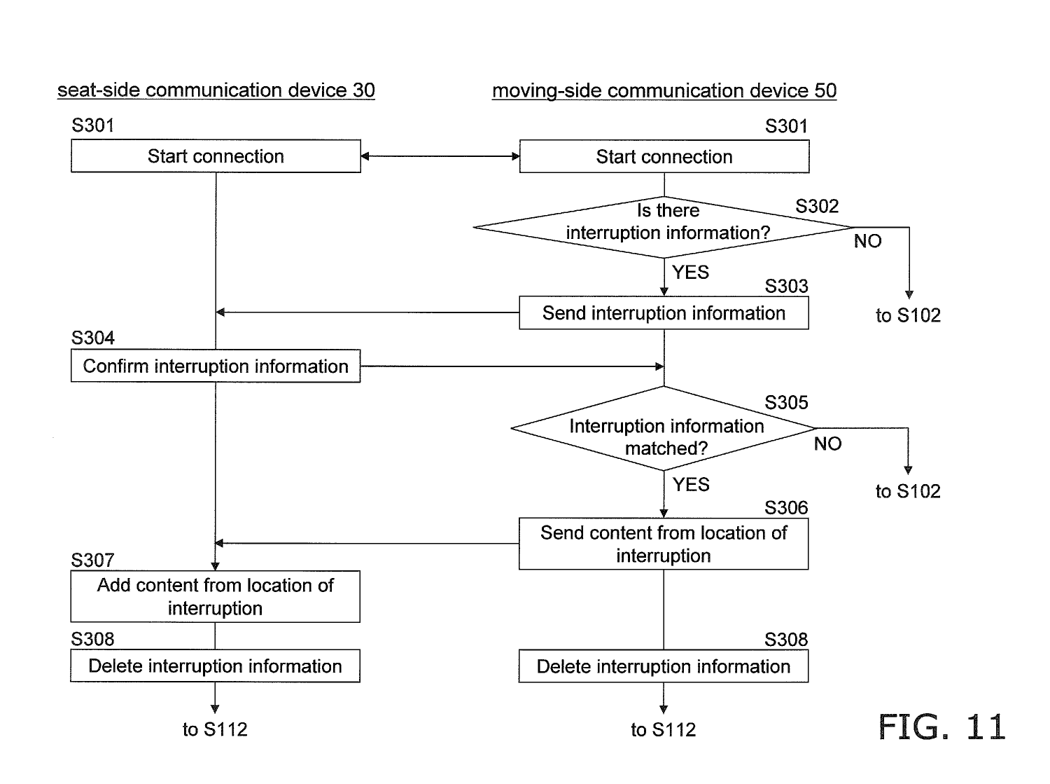

FIGS. 10 and 11 show the processing performed by the wireless communication system 1 when the connection between the seat-side communication device 30 and the moving-side communication device 50 is interrupted by something, such as when the movable cart 102 moves outside the communication range. Since the movable cart 102 is moved up and down the aisle by a flight attendant, even if it moves out of the communication range, there is a high probability that it will move back into the communication range.

FIG. 10 shows the processing performed by the seat-side communication device 30 and the moving-side communication device 50 when connection has been interrupted.

Step S201: The seat-side communication device 30 and the moving-side communication device 50 begin connecting. This connection processing corresponds to step S101 in FIG. 6. At this point, ID information that identifies the seat-side communication device 30 is also acquired.

Step S202: If the connection should be interrupted for some reason, the controller 34 of the seat-side communication device 30 and the controller 54 of the moving-side communication device 50 each determine that the connection has been interrupted.

This determination may be accomplished by detecting a state in which communication is impossible, or by detecting that communication rate is below a specific level.

Step S203: The controller 34 of the seat-side communication device 30 produces interruption information including information about the position in data at which the connection is interrupted during transmission, and stores this information in a memory, etc. The controller 54 of the moving-side communication device 50 produces ID information for identifying the seat-side communication device 30, and interruption information including the information about the position in data at which the connection is interrupted during transmission, and stores this information in a memory, etc.

This interruption information may be produced only when the transmission of content (step S110 in FIG. 6) is interrupted, and may not be produced when the transmission of content information, a request, or a command (steps S102 to S109 in FIG. 6) is interrupted. For the transmission of content, the amount of data being transmitted is large, and therefore, interruption is more likely to occur, and redoing the transmission from the start is an impediment to efficient communication.

FIG. 11 shows the processing performed when connection is restarted after an interruption (such as when the movable cart 102 having the moving-side communication device 50 that had been connected moves back into the communication range).

Step S301: The seat-side communication device 30 and the moving-side communication device 50 begin connecting. This connection processing corresponds to step S101 in FIG. 6. ID information for identifying the seat-side communication device 30 is also acquired at this point.

Step S302: The controller 54 of the moving-side communication device 50 determines whether or not interruption information is stored in the memory, etc. If interruption information is stored, this means that the transmission of data to the seat-side communication device 30 has been interrupted, so the flow proceeds to step S303. If no interruption information is stored, the flow proceeds to step S102 in FIG. 6, and normal data transmission and reception processing is performed.

Step S303: The controller 54 of the moving-side communication device 50 sends interruption information to the seat-side communication device 30 and requests that it be checked.

Step S304: The controller 34 of the seat-side communication device 30 checks the interruption information received from the moving-side communication device 50 against the interruption information it has stored, and sends the moving-side communication device 50 a response including the result of this check.

Step S305: The controller 54 of the moving-side communication device 50 determines whether or not the interruption information matches that of the seat-side communication device 30, on the basis of the response from the seat-side communication device 30. If there is a match, the flow proceeds to step S306, and otherwise the flow proceeds to step S102 in FIG. 6 and normal data transmission and reception processing is performed.

Step S306: After receiving a content send command from the seat-side communication device 30, the controller 54 of the moving-side communication device 50 sends data starting from the position at which the interruption occurred.

Step S307: The seat-side communication device 30 receives the content starting from the position at which the interruption occurred, and stores it in the data memory 35.

Step S308: In the moving-side communication device 50 and the seat-side communication device 30, once the controller 54 and the controller 34 each confirm the completion of the transmission and reception of the content starting from the position at which the interruption occurred, the stored interruption information is deleted.

The controller 54 of the moving-side communication device 50 or the controller 34 of the seat-side communication device 30 may also delete interruption information stored in the memory after a specific length of time has elapsed. This is because the movable cart 102 may not return to an area where reconnection is possible.

(3)

In the above embodiment, a request for content information was sent from the moving-side communication device 50 to the seat-side communication device 30 after the start of connection, but this is not the only option. The controller 34 of the seat-side communication device 30 may send a request for content information to the moving-side communication device 50 that has begun connecting (the same as step S102 in FIG. 6), check the content information received from the moving-side communication device 50 against the content information it holds itself (the same as step S106 in FIG. 6), determine whether or not content needs to be deleted or added, and then either delete or add content according to this determination.

Also, in the processing in FIG. 11, the determination of whether or not there is interruption information (step S302) and the transmission of interruption information (step S303) may also be performed by the seat-side communication device 30 against the moving-side communication device 50.

(4)

In the above embodiment, the seat-side communication device 30 was connected to the moving-side communication device 50 of a single movable cart 102, but this is not the only option, and it may instead be connected to the moving-side communication devices 50 of a plurality of movable carts 102. A case will now be described in which connection to another moving-side communication device 50 is made after the connection to one moving-side communication device 50 has been interrupted.

When the interruption processing shown in FIGS. 10 and 11 is performed, at the point when connection to one of the moving-side communication devices 50 has been interrupted, the moving-side communication device 50 or the seat-side communication device 30 sends the interruption information thus produced to a wireless access point installed onboard.

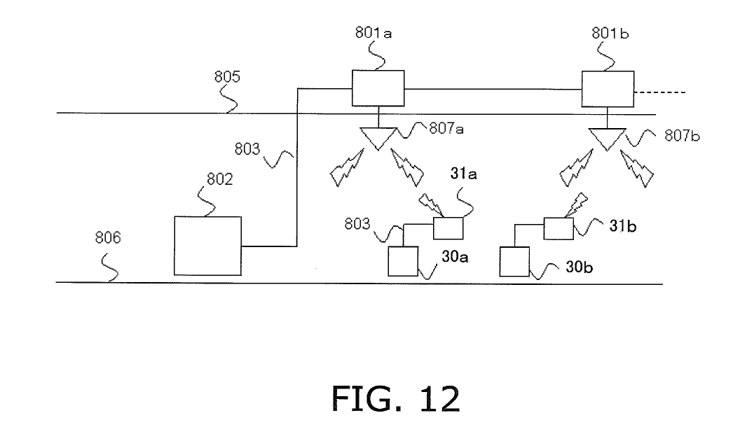

As shown in FIG. 12, wireless access points 807a and 807b are each a wireless communication device comprising a wireless communication component, a memory, and a CPU or other such controller that executes the various functions of a wireless access point. In FIG. 12, 802 is a server, 801a and 801b are relays, 30a and 30b are seat-side communication devices 30 installed at the seats, 805 is the cabin ceiling, 806 is the cabin floor, and 803 is a wired network. The seat-side communication devices 30a and 30b respectively have antennas 31a and 31b disposed on the aisle just as in the above embodiment and are connected to the wireless access points 807a and 807b.

For example, the wireless access point 807a stores in the memory the interruption information received from one moving-side communication device 50 or seat-side communication device 30. When another moving-side communication device 50 can be connected to the wireless access point 807a, interruption information (including ID information about the seat-side communication device) is acquired from the wireless access point 807a and stored in a memory, etc. When the other moving-side communication device 50 can be connected to the seat-side communication device 30 corresponding to this interruption information, the interruption information is checked, and content is added or deleted.

Consequently, the seat-side communication device 30 can be connected to a plurality of moving-side communication devices 50, and data transmission based on interruption information from a plurality of moving-side communication devices 50 is possible.

(5)

In the above embodiment, the moving-side communication device 50 compared the content information it has stored with that of the seat-side communication device 30, and if there was a difference, content was automatically added or deleted, but this is not the only option. The moving-side communication device 50 may provide content in response to a request. In this case, the flight attendant pushing the movable cart 102 may operate an input means connected to the moving-side communication device 50 in response to a request from a passenger, for example, to send the requested content from the moving-side communication device 50 to the seat-side communication device 30.

(6)

In the above embodiment, one moving-side communication device 50 or one seat-side communication device 30 may have a plurality of antenna components, and these antenna components may be installed at a plurality of locations.

(7)

In the above embodiment, when a plurality of moving-side communication devices 50 are used simultaneously, or when a plurality of antenna components are installed in the moving-side communication device 50, wireless communication may be performed by providing different channels so that the radio waves do not interfere with each other.

(8)

Terms indicating degree, such as “substantially,” “about,” and “approximately,” which may be used in this disclosure mean that a reasonable range of variance is permitted in the terms, to the extent that the results eventually obtained do not change greatly, for example.

Also, terms such as “horizontal,” “vertical,” and “perpendicular” are not limited to the strict definition of “horizontal,” “vertical,” or “perpendicular,” and encompass a certain angle or inclination with respect to “horizontal,” “vertical,” or “perpendicular,” to the extent that the results eventually obtained do not change greatly.

This disclosure can be applied as a communication device or wireless communication system with which a stable communication band needs to be ensured during content streaming or transmission.

What is claimed is:

1. A communication device that is capable of communicating with one other communication device attached to an attachment face on a fixed object, the communication device being attached to a moving vehicle that moves substantially parallel to the attachment face on the fixed object, said communication device comprising:
a first moving vehicle face disposed so as to be substantially parallel to a direction in which the moving vehicle moves, the first moving vehicle face facing the attachment face on the fixed object;
a second moving vehicle face disposed on a bottom face of the moving vehicle;
a third moving vehicle face disposed so as to face in a forward or backward movement direction of the moving vehicle;
an antenna component configured to wirelessly send and receive data to and from the one other communication device; and
a controller configured to control transmission and reception of the data,
wherein the antenna component is disposed on one or more of the first moving vehicle face, the second moving vehicle face and the third moving vehicle face, or on a line of intersection between any two of the first moving vehicle face, the second moving vehicle face and the third moving vehicle face.

2. The communication device according to claim 1,
wherein the moving vehicle has a cuboid shape having two opposing first moving vehicle faces, the second moving vehicle face and two opposing third moving vehicle faces, and
a plurality of the antenna components are disposed on at least two of the two opposing first moving vehicle faces, the second moving vehicle face and the two opposing third moving vehicle faces, or are disposed on a line of intersection between any two of the first moving vehicle face, the second moving vehicle face and the third moving vehicle face.

3. The communication device according to claim 1,
wherein the moving vehicle moves along an aisle,
the fixed object is a seat, and
the communication device is configured to be wirelessly connectable with a plurality of other communication devices attached to a plurality of seats installed along the aisle.

4. A communication device that is capable of wireless communication with one other communication device and is attached to a fixed object adjacent to an aisle that allows passage of a moving vehicle, said communication device comprising:
a first attachment face disposed so as to face the aisle;
an antenna component configured to wirelessly send and receive data to and from the one other communication device; and
a controller configured to control transmission and reception of the data,
wherein at least the antenna component is disposed on the first attachment face.

5. The communication device according to claim 4,
further comprising a second attachment face having a horizontal face that is substantially perpendicular to the first attachment face,
wherein the antenna component is disposed on at least one of the first attachment face and the second attachment face, or on a line of intersection between the first attachment face and the second attachment face.

6. The communication device according to claim 4,
wherein a plurality of the antenna components are disposed on the first attachment face.

7. The communication device according to claim 5,
wherein a plurality of the antenna components are disposed on the first attachment face and the second attachment face.

8. The communication device according to claim 4,
wherein the fixed object is a seat including a display component that displays the data, and
the controller is connected to the display component and causes the display component to display the data.

9. The communication device according to claim 8,
wherein the controller is connected to the display components of a plurality of seats, and causes each of the display components to display the data.

10. A wireless communication system, comprising a first communication device attached to a moving vehicle that moves along an aisle, and a second communication device provided on a fixed object and including a wireless communication function disposed on a first attachment face that is substantially parallel to a direction in which the moving vehicle moves,
wherein the first communication device includes:
a first moving vehicle face disposed so as to be substantially parallel to a direction in which the moving vehicle moves, the first moving vehicle facing the first attachment face on the fixed object;
a second moving vehicle face disposed on a bottom face of the moving vehicle;
a third moving vehicle face disposed so as to face in a forward or backward movement direction of the moving vehicle;
a first antenna component disposed on one or more of the first moving vehicle face, the second moving vehicle face and the third moving vehicle face, or on a line of intersection between any two of the first moving vehicle face, the second moving vehicle face and the third moving vehicle face, the first antenna being configured to wirelessly send and receive data to and from the second communication device; and
a first controller configured to control transmission and reception of the data, and
the second communication device includes:
the first attachment face disposed so as to face the first moving vehicle faces;
a second antenna component disposed on the first attachment face and configured to wirelessly send and receive data to and from the first communication device; and
a second controller configured to control the transmission and reception of the data.

11. The wireless communication system according to claim 10,
wherein the first communication device is attached to a plurality of moving vehicles that move along a plurality of aisles, and
a plurality of the first communication devices are connected to the second communication device via different wireless channels.

12. The wireless communication system according to claim 10,
wherein the moving vehicle moves along an aisle,
the fixed object is a seat,
the second communication devices are attached to a plurality of seats disposed along the aisle, and
the first communication device is wirelessly connectable to the plurality of second communication devices.

13. The wireless communication system according to claim 12,
wherein a plurality of seats are disposed flanking a single aisle,
the moving vehicle has a cuboid shape having two opposing first moving vehicle faces, the second moving vehicle face and two opposing third moving vehicle faces, and
the first antenna component of the first communication device is disposed on each of the two first moving vehicle faces.

14. The wireless communication system according to claim 12,
wherein a plurality of seats are disposed in a row perpendicular to the aisle and in a row along the aisle, and
the second antenna component of the second communication device is disposed only on the first attachment faces of the seats that are adjacent to the aisle.

15. The wireless communication system according to claim 14,
wherein each of the plurality of seats have a display component that displays the data, and
the second controller corresponding to the second antenna component of the second communication device is connected to the plurality of display components of the seats disposed in each row perpendicular to the aisle, and causes the data to be displayed on the plurality of display components in the each row.
